(19) United States
(12) Patent Application Publication
(10) Pub. No.: US 2012/0325507 A1
(43) Pub. Date: Dec. 27, 2012

(54) Portable Tool with Wireless Measured Value Transmission

(75) Inventors: Andreas Fluhrer, Murrhardt (DE); Manuel Rieger, Schwaebisch Hall (DE); Achim Kugler, Gschwend (DE)

(73) Assignee: Robert Bosch GmbH, Stuttgart (DE)

(21) Appl. No.: 13/528,625

(22) Filed: Jun. 20, 2012

(30) Foreign Application Priority Data
Jun. 22, 2011 (DE) 10 2011 105 306.2

(51) Int. Cl. B25B 23/00

(52) U.S. Cl. 173/20; 173/217

(57) ABSTRACT

A portable tool includes an electric motor drive, an output body, a detection device, and a transmission device. The output body can be rotated about a predefined axis. The detection device detects at least one physical measured value which is characteristic of the output operation with the output body. The transmission device transmits the physical parameter contactlessly from a rotating region of the tool to a stationary region of the tool. The transmission device includes a rotor coil and a stator coil. The rotor coil rotates with respect to the stator coil. The stator coil is configured without a former in a region between the stator coil and the rotor coil.

This application claims priority under 35 U.S.C. §119 to patent application no. DE 10 2011 105 306.2, filed on Jun. 22, 2011 in Germany, the disclosure of which is incorporated herein by reference in its entirety.

The present disclosure relates to a portable tool and, in particular, a portable screwdriver. Portable tools of this type have been known for a long time from the prior art, for example in the form of handheld screwdrivers, battery-driven screwdrivers or else hand drills.

### BACKGROUND

In the prior art, tools of this type are likewise known which have wireless measured signal transmission, for example the transmission of measured torque data, from a rotating region of the tool to a stationary region of the tool. For instance, EP 2 246 680 A2 describes a power tool having a contactless torque measuring device and a method for measuring the torque in a power tool. Here, a first coil is provided, as is a second coil which is arranged on the drive shaft or the motor shaft and is coupled to a torque sensor.

The said apparatus therefore permits contactless signal transmission which is used in measured value sensors for stationary tools. However, this type of signal transmission has the disadvantage that it requires a relatively large amount of installation space and is therefore if anything unsuitable for portable devices. In addition, transmission devices of this type also require very stable bearing devices, in order to maintain the very small gap between the two said coils even under loading, or in order to also avoid contact between the two coils during operation.

The present disclosure is therefore based on the object of providing a portable tool which permits transmission of measured values, such as torque data.

### SUMMARY

A portable tool according to the disclosure and, in particular, a screwdriver has an electric motor drive and an output body which can be rotated about a predefined axis and serves, in particular, to carry out a working operation. Furthermore, the tool has a detection device which detects at least one physical parameter (or one measured value) which is characteristic of this output operation with the output body, and a transmission device which contactlessly or wirelessly transmits the physical parameter or a signal which is characteristic of the said parameter from a rotating region of the tool to a stationary region of the tool. Here, the said transmission device has a rotor coil and a stator coil, the rotor coil rotating with respect to the stator coil.

According to the disclosure, the stator coil is configured without a former in a region between the stator coil and the rotor coil.

It is therefore proposed to provide what is known as a statorless coil for the stator coil or, in general, the coil which is arranged on the outside radially with regard to a rotational axis. Here, the said statorless coil which can also be called an air core coil serves for the contactless signal transmission.

A head, such as a screw head, can be arranged, for example, on the said output body. A configuration of the coil without a former is understood as meaning that, in particular, no former is provided which carries the coil from the radial inner side. As a result of the omission of a former of this type, it is possible to increase the spacing between the two coils which are used for the contactless signal transmission. In this way, the process reliability can be improved, in particular for the use in battery-operated or power pack-operated tools for mobile screwdriving technology. More precisely, contact between the two coils can also be ruled out by the omission of the said coil former for the stator coil, and complicated bearing devices can also be omitted as a result of the increase in the air gap. Here, the stationary region of the tool is understood as meaning, in particular, a region of such a type which does not move with respect to, for instance, a hand of the user who is holding the tool, such as, in particular, a housing region or elements which are arranged fixedly with respect to the housing part, such as the stator coil and the like. Here, the output body is preferably configured integrally with a gage bar which detects the physical parameter or measured value. The measured value can be directly a detected value, but it would also be possible to transmit signals which are derived from the measured value and which are, in particular, also characteristic of the said measured value.

Furthermore, it is possible to reduce the energy requirement with an identical signal power, since two coils which are used for contactless signal transmission can be arranged closer to one another as a result of the embodiment of the stator coil as an air core coil. The increase in the gap between the two said coils which are used for the contactless signal transmission is therefore realized as a result of the use of what is known as an air core coil. The stator coil former, in particular, is therefore omitted.

In general, the two coils are a rotating signal transmission device and a stationary signal transmission device which transmit, in particular, inductive signals.

A radial air gap between the rotor coil and the stator coil is advantageously >0.2 mm, preferably >0.4 mm, preferably >0.5 mm and particularly preferably >0.6 mm. The air gap can therefore advantageously be increased to, for example, 0.7 mm, whereby the process reliability is increased, since contact of the two coils becomes more unlikely.

In a further advantageous embodiment, the stator coil is arranged on a former, the said former being arranged at least partially radially outside the stator coil. In particular, the stator coil can be arranged, or can be embedded or cemented, in a radially outer former, for example a housing or former part.

The stator coil is therefore advantageously cast integrally into a former material. The purchase of the former coil is therefore ensured by a holding device which holds the stator coil from the radial outside.

In a further advantageous embodiment, the former material is a casting resin. The stator coil is preferably encapsulated with a Wepox casting resin (VT3000) which is formed on the basis of epoxy resin. As a result of the use of a resin of this type, it is possible that only low heat development and also a low shrinking pressure are produced.

In a further advantageous embodiment, the stator coil is mounted by means of a bearing device and, in particular, by means of a ball bearing with respect to a rotating region of the tool (in particular, an output shaft or gage bar). Furthermore, the tool advantageously has a memory device which serves, for example, to store the calibration data of the gage bar and/or the output body (possibly with the air core coil assembly). Thus, for example, a printed circuit board including what is known as an EEPROM can be provided. The said printed circuit board can be integrated into the overall assembly of the air core coils. The abovementioned connection of the air core coil to the gage bar by way of a ball bearing can achieve a situation where the spacing between the two coils cannot vary. This could occur if the stator coil were cast directly into, for example, the half shells of battery-operated or power pack-operated tools, in particular for mobile screwdriving technology.

In a further advantageous embodiment, the physical parameter is selected from a group of parameters which comprises torques, rotational speeds, rotary angles, electric currents, electric voltages, combinations hereof and the like. The detection device is advantageously a torque detection device which can comprise, for example, a strain gage and which serves to detect the transmitted torques of the output body and/or the gage bar. The physical parameter or measured value is preferably a parameter or measured value of such a type which changes during working operation.

In a further advantageous embodiment, the tool has an energy store device for operating the electric motor drive. Thus, in particular, a battery or a rechargeable battery is provided which makes it possible that the tool itself can be operated without a power supply line.

In a further particularly preferred embodiment, the tool has a receiving device for wirelessly receiving control data for controlling the tool. Thus, for example, a central unit can stipulate a maximum torque. Furthermore, the tool advantageously also has a signal outputting device for wirelessly transmitting control data. Thus, for example, the measured actual torque values can be output to a central control device, and the latter can control the torque and/or a current feed to the drive as a reaction to the said values.

In a further advantageous embodiment, the tool therefore also has a control device for controlling the working operation, for example a screwdriving operation. The control device is therefore advantageously suitable for controlling the screwdriving operation on the basis of the abovementioned (in particular, measured) physical parameter.

The tool preferably has a measuring device for measuring the physical parameter. Here, the said measuring device is advantageously arranged so as to rotate during working operation.

Furthermore, the present disclosure is directed to a transmission device for the wireless and, in particular, inductive transmission of a physical measured value or parameter of a screwdriving operation, which transmission device has a rotor coil which is arranged such that it can be rotated with regard to a predefined rotational axis and serves as a transmitting device for the physical parameter, and has a stator coil which is arranged fixedly in terms of rotation and serves as a receiving device for the physical parameter. Here, one of the coils, and in particular the rotor coil, is arranged within the other coil in a direction which is radial with regard to the rotational axis.

According to the disclosure, a former of the radially outer coil, in particular of the stator coil, is configured in such a way that a space between the two coils remains substantially without a former. In this way, as mentioned above, the gap between the two coils can be increased.

### BRIEF DESCRIPTION OF THE DRAWINGS

Further advantages and embodiments result from the appended drawings, in which:

FIG. 1 shows a diagrammatic illustration of a tool according to the disclosure,

FIG. 2 shows a sectional illustration of a detection unit, and

FIG. 3 shows a perspective illustration of the detection unit.

### DETAILED DESCRIPTION

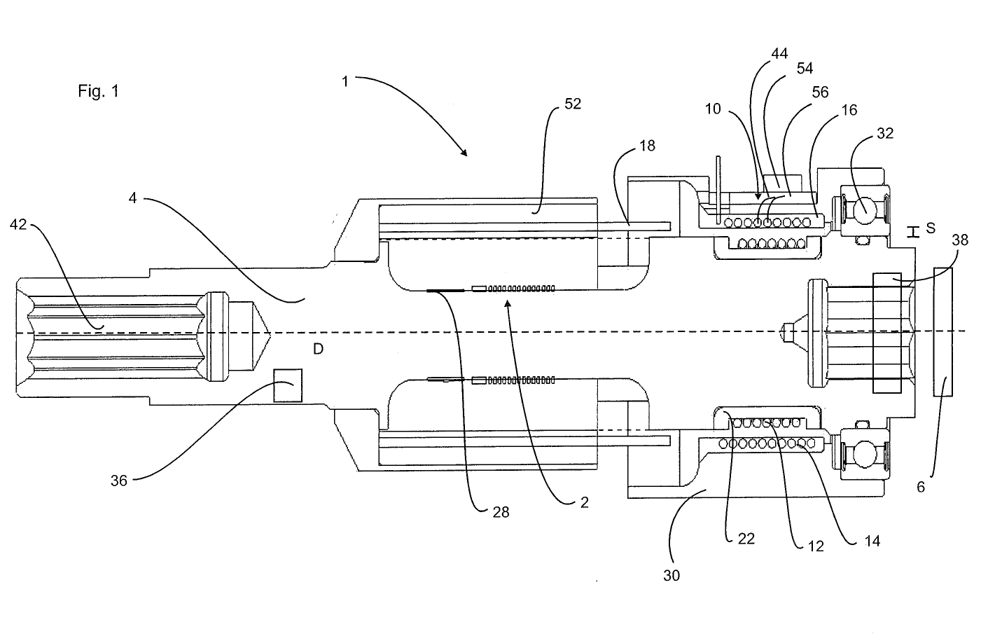

FIG. 1 shows a diagrammatic illustration of a part of a portable tool 1 according to the disclosure. Here, the said portable tool has a drive device (not shown), such as an electric motor, which, via a gear mechanism (not shown), drives an output shaft 4 which is denoted in its entirety by 4 such that it rotates about a rotational axis D. Here, the said output shaft also acts a gage bar for measuring physical parameters, such as, in particular, a torque. Furthermore, the tool has a detection device which is denoted in its entirety by 2 and detects a physical parameter of a working operation. Here, the said detection device 2 has a strain gage 28, with the aid of which a torque, for example a transmitted torque, can be detected. Here, said output shaft 4 is mounted such that it can be rotated with respect to a housing part 52 which can be of cup-shaped configuration. The reference numeral 42 relates to an output head, on which, for example, a screwdriving means can be arranged.

The reference numeral 18 identifies, in a roughly diagrammatic way, an electric transmission line for transmitting the electric signals to a transmission device which is denoted in its entirety by 10 and wirelessly transmits the measured values from the rotating region of the output body 4 to a stationary region of the tool. The reference numeral 30 identifies the stationary region of the tool in its entirety.

Here, the said detection device 10 has a rotor coil 12 which is arranged on a former 22.

The reference numeral 14 identifies a stator coil which, as mentioned in the introduction, is configured without a former or as an air core coil and is held by a holding device 16, for example is cast integrally into the said holding device. The reference numeral 30 identifies a stationary housing part, on which, for example, the stator coil 14 can also be arranged. Here, the coil 14 can be configured as a double winding with two wires which, for example, can be soldered onto a printed circuit board. The reference sign S identifies a gap which is formed between the stator coil 14 and the rotor coil 12. The said gap is larger than in the prior art as a result of the embodiment of the stator coil without a former.

The reference numeral 54 identifies a memory device such as an EEPROM. Here, the said memory device 54 is arranged on a printed circuit board 56.

Here, the said printed circuit board can also be configured as a unit with the former unit 16 for the rotor coil 14.

In addition to the bearings 32, further bearings 36 are shown (diagrammatically) which likewise mount the output body 4 rotatably. The reference numeral 44 identifies electric lines which forward the signal of the rotor coil 14. The reference numeral 38 identifies (likewise only roughly diagrammatically) a gear mechanism in its entirety which is connected between an (in particular, electric) drive device 6 and the output body 4 and which preferably steps down a rotational speed of the drive device.

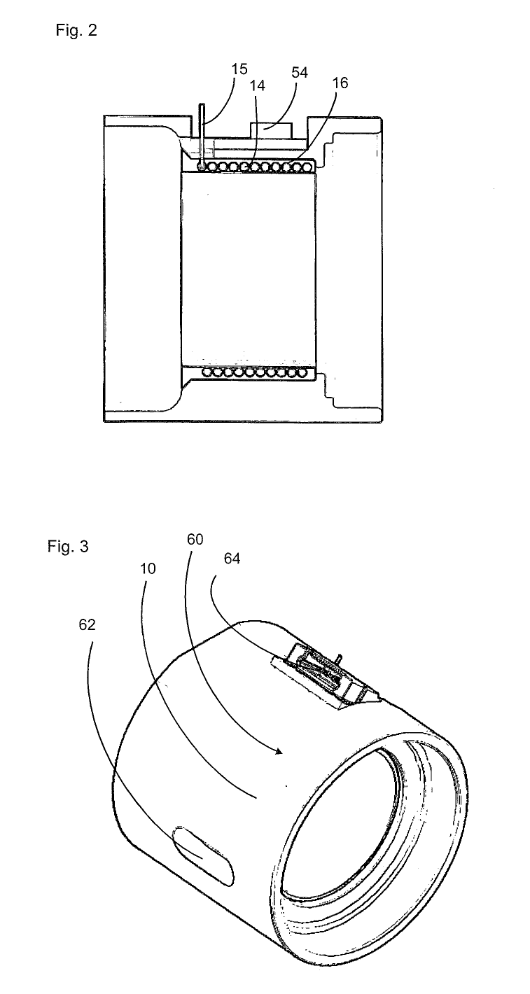

FIG. 2 shows a further illustration of the transmission device 10. Here, once again the rotor coil 14 can be seen which is arranged on the holding device 16. The memory device 54 which can be arranged on the holding or former device 16 is also shown here.

FIG. 3 shows a perspective illustration of the transmission device 10. Here, the reference numeral 64 relates to a connection device for picking off the measured values, it also being possible for a cordless or wireless transmission device to be provided at this location, which transmission device transmits the measured values by radio to a central unit (not shown). The reference numeral 62 identifies an opening, by means of which a housing part which can carry, for example, the stator coil can be screwed to the housing part 60.

The applicant reserves the right to claim as essential to the disclosure all the features which are disclosed in the application, as long as they are novel over the prior art individually or in combination.

What is claimed is:

1. A portable tool, comprising:
an electric motor drive;
an output body configured to be rotated about a predefined axis;
a detection device configured to detect at least one physical measured value which is characteristic of the output operation with the output body; and
a transmission device configured to transmit the physical measured value contactlessly from a rotating region of the tool to a stationary region of the tool, the transmission device having a rotor coil and a stator coil, and the rotor coil rotating with respect to the stator coil,
wherein the stator coil is configured without a former in a region between the stator coil and the rotor coil.

2. The portable tool according to claim 1, wherein a radial air gap between the rotor coil and the stator coil is greater than 0.2 mm, preferably greater than 0.4 mm, preferably greater than 0.5 mm and particularly preferably greater than 0.6 mm.

3. The portable tool according claim 1, wherein:
the stator coil is arranged on a former, and
the former is arranged at least partially radially outside the stator coil.

4. The portable tool according to claim 1, wherein the stator coil is cast integrally into a former material.

5. The portable tool according to claim 4, wherein the former material is a casting resin.

6. The portable tool according to claim 1, wherein the stator coil is mounted by means of a bearing device with respect to a rotating region of the tool.

7. The portable tool according to claim 1, wherein the physical measured value is selected from a group of measured values which comprises torques, rotational speeds, rotary angles, electric currents, electric voltages, and combinations thereof and the like.

8. The portable tool according claim 1, wherein the tool has an energy store device for operating the electric motor drive.

9. The portable tool according to claim 1, further comprising:
a receiving device configured to wirelessly receive control data for controlling the tool.

10. A transmission device for the wireless transmission of a physical measured value of a screwdriving operation, comprising:
a rotor coil which is arranged such that it can be rotated with regard to a predefined rotational axis and serves as a transmitting device for the physical measured value; and
a stator coil which is arranged fixedly in terms of rotation and serves as a receiving device for the physical parameter,
wherein one of the rotor coil and the stator coil is arranged within the other of the rotor coil and the stator coil in a direction which is radial with regard to the rotational axis, and
wherein a former of the radially outer coil is configured in such a way that a space between the rotor coil and the stator coil remains substantially without a former.

11. The transmission device according to claim 10, wherein the physical measured value is inductively transmitted.
